(19) United States
(12) Patent Application Publication
(10) Pub. No.: US 2010/0083269 A1
(43) Pub. Date: Apr. 1, 2010

(54) ALGORITHM FOR FAST LIST ALLOCATION AND FREE

(75) Inventor: James Bernard Moody, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/240,277

(22) Filed: Sep. 29, 2008

(51) Int. Cl. G06F 9/50

(52) U.S. Cl. 718/104

(57) ABSTRACT

A computer implemented method, a data processing system, and a computer usable recordable-type medium having a computer usable program code serializing list insertion and removal. An atomic operation free atomic list primitive call from a kernel service is received for the insertion or removal of a list element from a linked list. The atomic operation free atomic list primitive is a restartible routine selected from the list consisting of cpuget_from_list, cpuput_onto_list, cpuget_all_from_list, and cpuput_chain_onto_list. A processor begins execution of the atomic operation free atomic list primitive. If an interrupt is received during execution of the atomic operation free atomic list primitive, the interrupt handler will recognize the address of the executing program at the time of the interrupt and will over-write that address in the machine state save area, so that when the interrupted program is resumed, the entire sequence will be run again from the beginning. If an interrupt is not received during execution of the atomic operation free atomic list primitive interrupt hander, the processor finishes execution of the atomic operation free atomic list primitive.

### BACKGROUND OF THE INVENTION

1. Field of the Invention

The present invention relates generally to a computer implemented method, a data processing system, and a computer program product. More particularly, the present invention relates to a computer implemented method, a data processing system, and a computer program product for an algorithm providing fast list allocations and list frees.

2. Description of the Related Art

The UNIX operating system is a multi-user operating system supporting a hierarchical directory structure for the organization and maintenance of files. In contrast with a single operating system, UNIX is a class of similar operating systems. There are dozens of different implementations of UNIX, such as Advanced Interactive Executive (AIX), a version of UNIX produced by International Business Machines Corporation. Each implementation is similar to use because each provides a core set of basic UNIX commands.

The UNIX operating system is organized at three levels: the kernel, shell, and utilities. The kernel is the software that manages a user program's access to the system hardware and software resources, such as scheduling tasks, managing data/file access and storage, and enforcing security mechanisms. The shell presents each user with a prompt, interprets commands typed by a user, executes user commands, and supports a custom environment for each user. The utilities provide tools and applications that offer additional functionality to the operating system.

In the AIX operating system, kernel atomic operations comprise reserve and conditional store instructions for reading and writing to a shared location. Reservation instructions and partnering conditional store instructions are often referred to as load and reserve indexed (LARX) instructions and store conditional indexed (STCX) instructions. In particular, a LARX instruction first creates a reservation for a memory location for use by a partnered STCX instruction. The STCX instruction is subsequently executed if the reservation has remained valid. In other words, if the reservation is lost, the conditional store in the STCX operation will not be performed. The reservation set by the LARX instruction may be lost if the memory location has been modified by the CPU, another CPU, or another device prior to the execution of the partnered STCX instruction. In this situation, rather than perform the conditional store instruction, the STCX will set the zero bit in the status register. A branch instruction, which tests this bit, will branch backwards to retry the atomic operation again. In this manner, the atomicity code keeps refetching and conditionally writing until it determines that the memory location has not been modified between the execution of the LARX and STCX instructions.

In addition, a reservation may also be lost whenever an interrupt occurs in the AIX operating system. When an interrupt occurs, the AIX kernel always uses a LARX/STCX operation to process the interrupt. However, as a side effect of the interrupt, the interrupted program's LARX reservation is lost. This reservation is lost even though the LARX/STCX used while processing the interrupt is not storing into the memory location reserved by the first LARX reservation.

In the UNIX environment, the LARX/STCX operations are used frequently by UNIX operating systems to primitives. Primitives utilizing the LARX/STCX operations, such as get from_list( ), put_onto_list( ), get all_from_list( ), and put_chain_onto_list( ), are frequently used by the UNIX operating system to serialize list allocation processes and list free processes. List allocation is the removal of an element or all elements from the top of a linked list. List free is the placement of an element or a chain of elements to the head of a linked list. While the primitives are very efficient with respect to their instruction count, the underlying LARX/STCX operations of the primitives are very expensive in terms of processor utilization.

### BRIEF SUMMARY OF THE INVENTION

According to one embodiment of the present invention a computer implemented method, a data processing system, and a computer usable recordable-type medium having a computer usable program code serialize list insertion and removal. An atomic operation free atomic list primitive call from a kernel service is received for the insertion or removal of a list element from a linked list. The atomic operation free atomic list primitive is a restartible routine selected from the list consisting of cpuget_from_list, cpuput_Onto_list, cpuget_all_from_list, and cpuput_chain_onto_list. A processor begins execution of the atomic operation free atomic list primitive. If an interrupt is received during execution of the atomic operation free atomic list primitive, the interrupt handler will recognize the address of the executing program at the time of the interrupt, and will over-write that address in the machine state save area, so that when the interrupted program is resumed, the entire restartable sequence will be run again from the beginning. If an interrupt is not received during execution of the atomic operation free atomic list primitive, the processor completes execution of the atomic operation free atomic list primitive sequence of instructions.

### BRIEF DESCRIPTION OF THE SEVERAL VIEWS OF THE DRAWINGS

FIG. 1 is a block diagram of a data processing system in which illustrative embodiments may be implemented;

FIG. 2 is a block diagram of an exemplary logical partitioned platform in which illustrative embodiments may be implemented;

FIG. 3 is a block diagram of a processor system for processing information according to the preferred embodiment;

FIG. 4 is a flow chart for the processing of atomic operation free atomic list primitives according to an illustrative embodiment;

FIG. 5 is an exemplary diagram illustrating a linked list according to an illustrative embodiment;

FIG. 6 is a flowchart illustrating a retrieval of a list element from a linked list according to an illustrative embodiment;

FIG. 7 is a flowchart illustrating an allocation of a list element to a linked list according to an illustrative embodiment;

FIG. 8 is a flowchart illustrating a retrieval of all list elements from a linked list is shown according to an illustrative embodiment; and

FIG. 9 is a flowchart illustrating an allocation of a list element chain to a linked list is shown according to an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

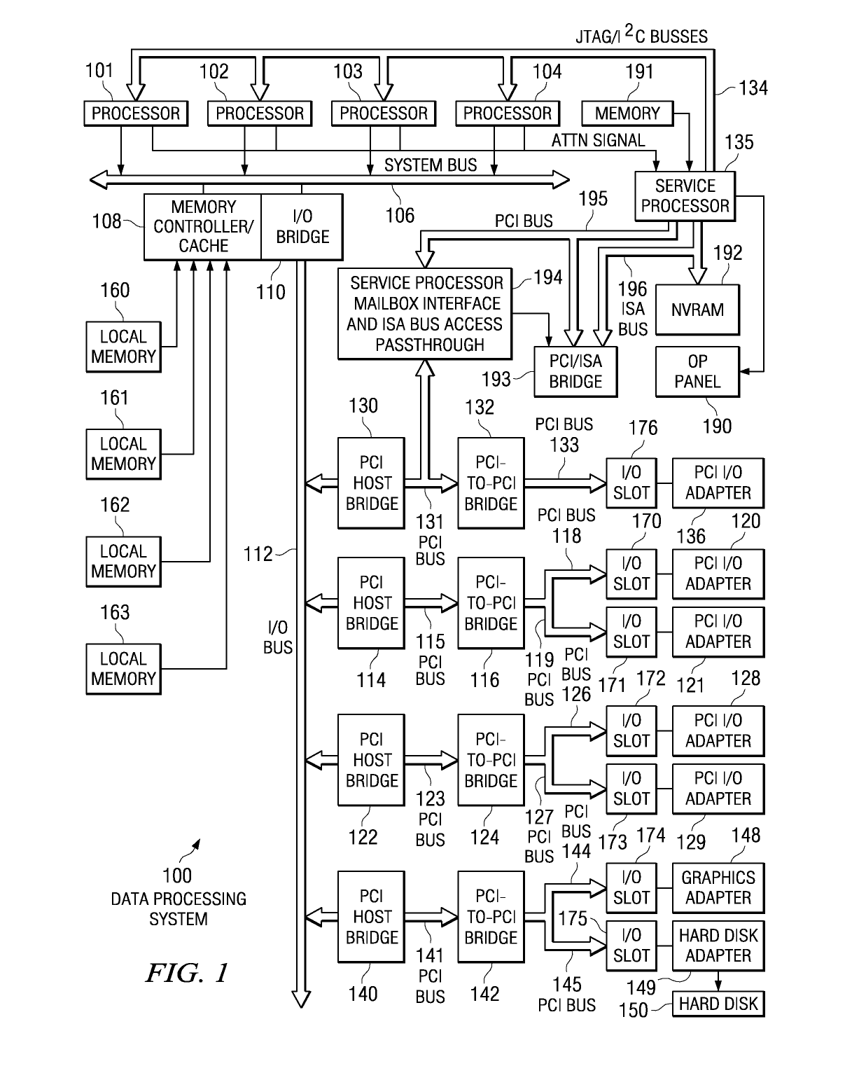

With reference now to the figures, and in particular with reference to FIG. 1, a block diagram of a data processing system in which illustrative embodiments may be implemented is depicted. Data processing system 100 may be a symmetric multiprocessor (SMP) system including processors 101, 102, 103, and 104, which connect to system bus 106. For example, data processing system 100 may be an IBM eServer, a product of International Business Machines Corporation in Armonk, N.Y., implemented as a server within a network. Alternatively, a single processor system may be employed. Also connected to system bus 106 is memory controller/cache 108, which provides an interface to local memories 160, 161, 162, and 163. I/O bridge 110 connects to system bus 106 and provides an interface to I/O bus 112. Memory controller/cache 108 and I/O bridge 110 may be integrated as depicted.

Data processing system 100 is a logical partitioned (LPAR) data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120, 121, 128, 129, and 136, graphics adapter 148, and hard disk adapter 149 may be assigned to different logical partitions. In this case, graphics adapter 148 connects to a display device (not shown), while hard disk adapter 149 connects to and controls hard disk 150.

Thus, for example, suppose data processing system 100 is divided into three logical partitions, P1, P2, and P3. Each of PCI I/O adapters 120, 121, 128, 129, and 136, graphics adapter 148, hard disk adapter 149, each of host processors 101, 102, 103, and 104, and memory from local memories 160, 161, 162, and 163 is assigned to each of the three partitions. In these examples, memories 160, 161, 162, and 163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160, 161, 162, and 163, and I/O adapters 120, 128, and 129 may be assigned to logical partition P1; processors 102 and 103, some portion of memory from local memories 160, 161, 162, and 163, and PCI I/O adapters 121 and 136 may be assigned to partition P2; and processor 104, some portion of memory from local memories 160, 161, 162, and 163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX) operating system may be executing within partition P1, a second instance (image) of the AIX operating system may be executing within partition P2, and a Linux or OS/400 operating system may be operating within logical partition P3.

Peripheral component interconnect (PCI) host bridge 114 connected to I/O bus 112 provides an interface to PCI local bus 115. PCI I/O adapters 120 and 121 connect to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128 and 129. PCI I/O adapters 128 and 129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through 194 and PCI-to-PCI bridge 132. Service processor mailbox interface and ISA bus access pass-through 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101, 102, 103, and 104 via a plurality of JTAG/I²C busses 134. JTAG/I²C busses 134 are a combination of JTAG/scan busses (see IEEE 1149.1) and Phillips I²C busses. However, alternatively, JTAG/I²C busses 134 may be replaced by only Phillips I²C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I²C busses 134 to interrogate the system (host) processors 101, 102, 103, and 104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101, 102, 103, and 104, memory controller/cache 108, and I/O bridge 110. Any error information for failures detected during the BISTs, BATs, and memory tests are gathered and reported by service processor 135.

If a meaningful and valid configuration of system resources is still possible after taking out the elements found to be faulty during the BISTs, BATs, and memory tests, then data processing system 100 is allowed to proceed to load executable code into local (host) memories 160, 161, 162, and 163. Service processor 135 then releases host processors 101, 102, 103, and 104 for execution of the code loaded into local memory 160, 161, 162, and 163. While host processors 101, 102, 103, and 104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101, 102, 103, and 104, local memories 160, 161, 162, and 163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for de-configuration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to illustrative embodiments.

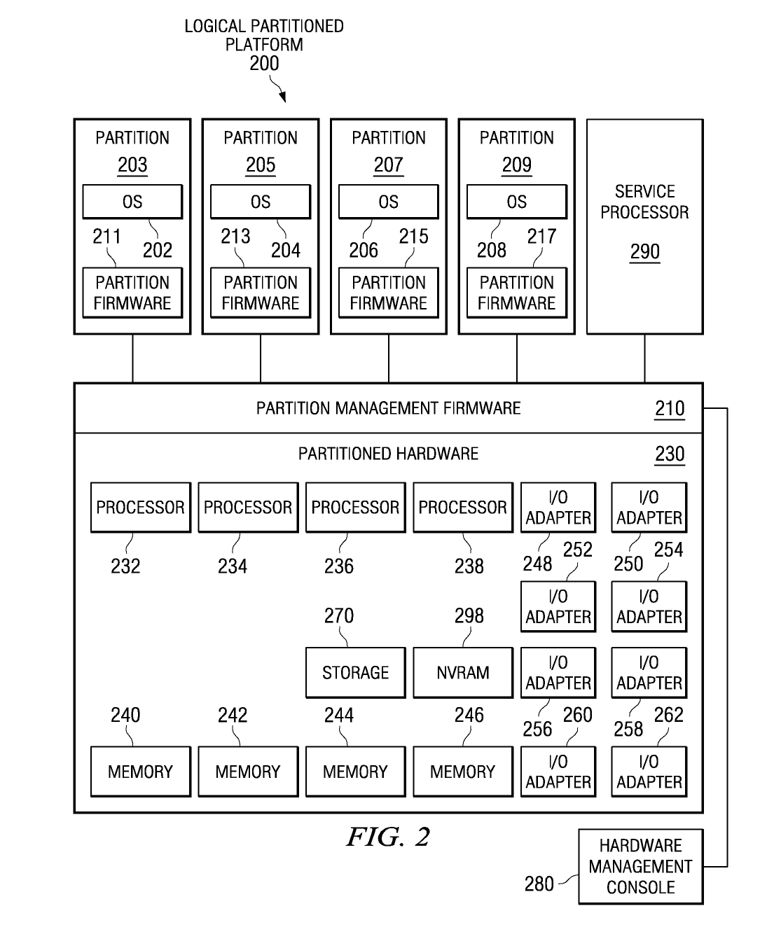

With reference now to FIG. 2, a block diagram of an exemplary logical partitioned platform is depicted in which illustrative embodiments may be implemented. The hardware in logical partitioned platform 200 may be implemented as, for example, data processing system 100 in FIG. 1. Logical partitioned platform 200 includes partitioned hardware 230, operating systems 202, 204, 206, 208, and partition management firmware 210. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor, which is available from International Business Machines Corporation. OS/400 is used only as an example in these illustrative embodiments. Of course, other types of operating systems, such as AIX and Linux, may be used depending on the particular implementation. Operating systems 202, 204, 206, and 208 are located in partitions 203, 205, 207, and 209. Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes processors 232, 234, 236, and 238, memories 240, 242, 244, and 246, input/output (I/O) adapters 248, 250, 252, 254, 256, 258, 260, and 262, and a storage unit 270. Each of processors 232, 234, 236, and 238, memories 240, 242, 244, and 246, NVRAM storage 298, and I/O adapters 248, 250, 252, 254, 256, 258, 260, and 262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

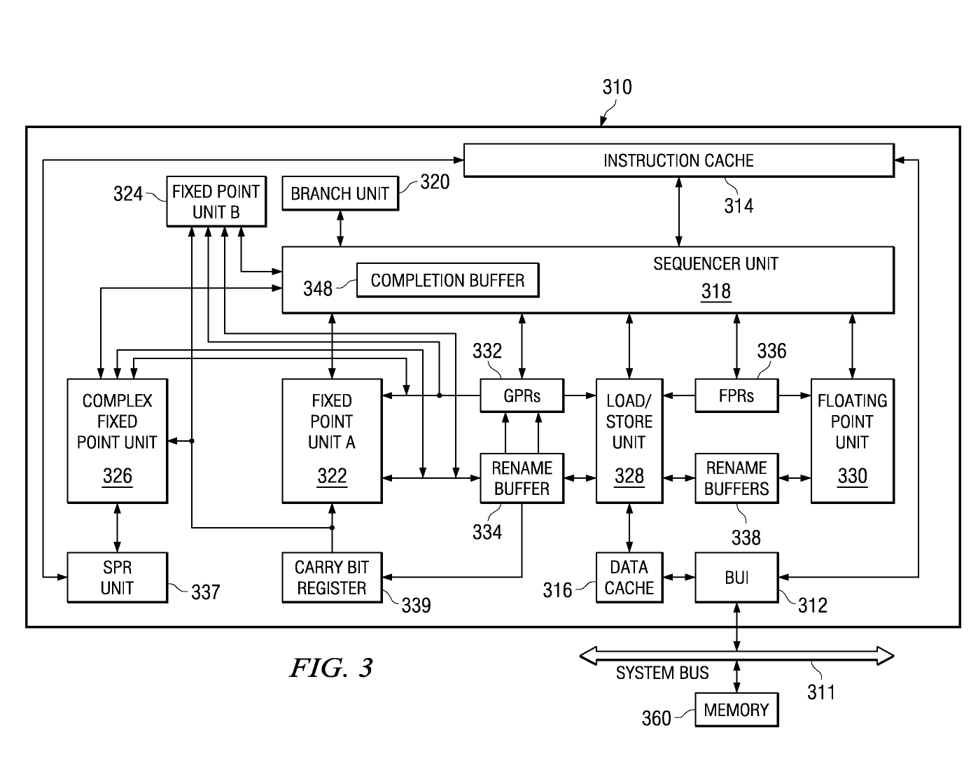

FIG. 3 is a block diagram of a processor system for processing information according to the preferred embodiment. In the preferred embodiment, processor 310 is a single integrated circuit superscalar microprocessor. Accordingly, as discussed further herein below, processor 310 includes various units, registers, buffers, memories, and other sections, all of which are formed by integrated circuitry. Also, in the preferred embodiment, processor 310 operates according to reduced instruction set computer (“RISC”) techniques. As shown in FIG. 3, a system bus 311 is connected to a bus interface unit (“BIU”) 312 of processor 310. BIU 312 controls the transfer of information between processor 310 and system bus 311.

BIU 312 is connected to an instruction cache 314 and to a data cache 316 of processor 310. Instruction cache 314 outputs instructions to a sequencer unit 318. In response to such instructions from instruction cache 314, sequencer unit 318 selectively outputs instructions to other execution circuitry of processor 310.

In addition to sequencer unit 318, in the preferred embodiment, the execution circuitry of processor 310 includes multiple execution units, namely a branch unit 320, a fixed-point unit A (“FXUA”) 322, a fixed-point unit B (“FXUB”) 324, a complex fixed-point unit (“CFXU”) 326, a load/store unit (“LSU”) 328, and a floating-point unit (“FPU”) 330. FXUA 322, FXUB 324, CFXU 326, and LSU 328 input their source operand information from general-purpose architectural registers (“GPRs”) 332 and fixed-point rename buffers 334. Moreover, FXUA 322 and FXUB 324 input a “carry bit” from a carry bit (“CA”) register 339. FXUA 322, FXUB 324, CFXU 326, and LSU 328 output results (destination operand information) of their operations for storage at selected entries in fixed-point rename buffers 334. Also, CFXU 326 inputs and outputs source operand information and destination operand information to and from special-purpose register processing unit (“SPR unit”) 337.

FPU 330 inputs its source operand information from floating-point architectural registers (“FPRs”) 336 and floating-point rename buffers 338. FPU 330 outputs results (destination operand information) of its operation for storage at selected entries in floating-point rename buffers 338.

In response to a Load instruction, LSU 328 inputs information from data cache 316 and copies such information to selected ones of rename buffers 334 and 338. If such information is not stored in data cache 316, then data cache 316 inputs (through BIU 312 and system bus 311) such information from a system memory 360 connected to system bus 311. Moreover, data cache 316 is able to output (through BIU 312 and system bus 311) information from data cache 316 to system memory 360 connected to system bus 311. In response to a store instruction, LSU 328 inputs information from a selected one of GPRs 332 and FPRs 336 and copies such information to data cache 316. Sequencer unit 318 inputs and outputs information to and from GPRs 332 and FPRs 336. From sequencer unit 318, branch unit 320 inputs instructions and signals indicating a present state of processor 310. In response to such instructions and signals, branch unit 320 outputs (to sequencer unit 318) signals indicating suitable memory addresses storing a sequence of instructions for execution by processor 310. In response to such signals from branch unit 320, sequencer unit 318 inputs the indicated sequence of instructions from instruction cache 314. If one or more of the sequence of instructions is not stored in instruction cache 314, then instruction cache 314 inputs (through BIU 312 and system bus 311) such instructions from system memory 360 connected to system bus 311.

In response to the instructions input from instruction cache 314, sequencer unit 318 selectively dispatches the instructions to selected ones of execution units 320, 322, 324, 326, 328, and 330. Each execution unit executes one or more instructions of a particular class of instructions. For example, FXUA 322 and FXUB 324 execute a first class of fixed-point mathematical operations on source operands, such as addition, subtraction, ANDing, ORing and XORing. CFXU 326 executes a second class of fixed-point operations on source operands, such as fixed-point multiplication and division. FPU 330 executes floating-point operations on source operands, such as floating-point multiplication and division.

As information is stored at a selected one of rename buffers 334, such information is associated with a storage location (e.g. one of GPRs 332 or CA register 339) as specified by the instruction for which the selected rename buffer is allocated. Information stored at a selected one of rename buffers 334 is copied to its associated one of GPRs 332 (or CA register 339) in response to signals from sequencer unit 318. Sequencer unit 318 directs such copying of information stored at a selected one of rename buffers 334 in response to “completing” the instruction that generated the information. Such copying is called “writeback.”

As information is stored at a selected one of rename buffers 338, such information is associated with one of FPRs 336. Information stored at a selected one of rename buffers 338 is copied to its associated one of FPRs 336 in response to signals from sequencer unit 318. Sequencer unit 318 directs such copying of information stored at a selected one of rename buffers 338 in response to “completing” the instruction that generated the information.

Processor 310 achieves high performance by processing multiple instructions simultaneously at various ones of execution units 320, 322, 324, 326, 328, and 330. Accordingly, each instruction is processed as a sequence of stages, each being executable in parallel with stages of other instructions. Such a technique is called “pipelining.” In a significant aspect of the illustrative embodiment, an instruction is normally processed as six stages, namely fetch, decode, dispatch, execute, completion, and writeback. In the fetch stage, sequencer unit 318 selectively inputs (from instruction cache 314) one or more instructions from one or more memory addresses storing the sequence of instructions discussed further hereinabove in connection with branch unit 320, and sequencer unit 318.

In the decode stage, sequencer unit 318 decodes up to four fetched instructions.

In the dispatch stage, sequencer unit 318 selectively dispatches up to four decoded instructions to selected (in response to the decoding in the decode stage) ones of execution units 320, 322, 324, 326, 328, and 330 after reserving rename buffer entries for the dispatched instructions' results (destination operand information). In the dispatch stage, operand information is supplied to the selected execution units for dispatched instructions. Processor 310 dispatches instructions in order of their programmed sequence.

In the execute stage, execution units execute their dispatched instructions and output results (destination operand information) of their operations for storage at selected entries in rename buffers 334 and rename buffers 338 as discussed further hereinabove. In this manner, processor 310 is able to execute instructions out-of-order relative to their programmed sequence.

In the completion stage, sequencer unit 318 indicates an instruction is “complete.” Processor 310 “completes” instructions in order of their programmed sequence.

In the writeback stage, sequencer 318 directs the copying of information from rename buffers 334 and 338 to GPRs 332 and FPRs 336, respectively. Sequencer unit 318 directs such copying of information stored at a selected rename buffer. Likewise, in the writeback stage of a particular instruction, processor 310 updates its architectural states in response to the particular instruction. Processor 310 processes the respective “writeback” stages of instructions in order of their programmed sequence. Processor 310 advantageously merges an instruction's completion stage and writeback stage in specified situations.

In the illustrative embodiment, each instruction requires one machine cycle to complete each of the stages of instruction processing. Nevertheless, some instructions (e.g., complex fixed-point instructions executed by CFXU 326) may require more than one cycle. Accordingly, a variable delay may occur between a particular instruction's execution and completion stages in response to the variation in time required for completion of preceding instructions.

A completion buffer 348 is provided within sequencer 318 to track the completion of the multiple instructions which are being executed within the execution units. Upon an indication that an instruction or a group of instructions have been completed successfully, in an application specified sequential order, completion buffer 348 may be utilized to initiate transfer of the results of those completed instructions to the associated general-purpose registers.

The illustrative embodiments provide a computer implemented method, a computer program product, and a data processing system for serializing list insertion and removal. By carefully organizing its contained data, a kernel service can use an atomic operation free atomic list primitive so that the target lists are only accessed by the owning CPU. The illustrative embodiments utilize a base address of a list structure, a stride of the list structure, and the offset into the structure of the list being updated to identify a linked list for each CPU within the data processing system. The disclosed primitive operations are then performed on the identified list that corresponds to the CPU on which the low level, primitive calling routine is executed.

A computer implemented method, a data processing system, and a computer usable recordable-type medium having a computer usable program code for serialize list insertion and removal. An atomic operation free atomic list primitive call from a kernel service is received for the insertion or removal of a list element from a linked list. The atomic operation free atomic list primitive is a restartible routine selected from the list consisting of cpuget_from_list, cpuput_onto_list, cpuget_all_from_list, and cpuput_chain_onto_list. A processor begins execution of the atomic operation free atomic list primitive. If an interrupt is received during execution of the atomic operation free atomic list primitive interrupt hander, an instruction address register in the interrupted machine state save area is reset to the first instruction in the sequence. If an interrupt is not received during execution of the atomic operation free atomic list primitive, the processor finishes execution of the atomic operation free atomic list primitive from its beginning.

The atomic operation free atomic list primitives are per-CPU list, restartable millicode routines, including cpuget_from_list, cpuput_Onto_list, cpuget_all_from_list, and cpuput_chain_onto_list. The atomic operation free atomic list primitives are implemented in millicode such that if any of the atomic operation free atomic list primitives are interrupted, a first level interrupt handler will have knowledge that the sequence has been interrupted, and the handler will reset the instruction address register in the interrupted machine state save area (MST) to the first instruction of the sequence. The entire atomic operation free atomic list primitive will then be restarted when the interrupted thread is resumed since the instruction address register points at the beginning of the routine after it is restored from the MST before resuming. Because the sequences in all the atomic list primitives are written so that they are restartable up to the terminating store that completes the list transaction, the interrupt hander has clear boundaries to determine restartability.

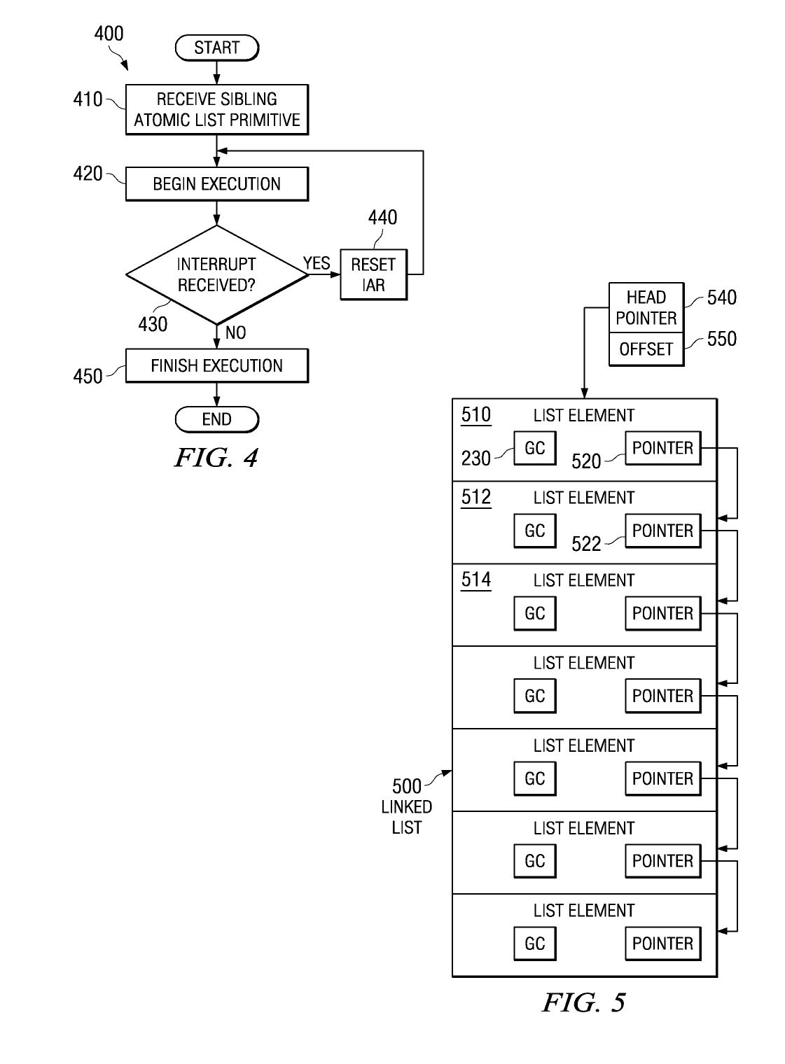

Referring now to FIG. 4, a flow chart for the processing of atomic operation free atomic list primitives is shown according to an illustrative embodiment. The atomic operation free atomic list primitives are per-CPU list, restartable millicode routines, including cpuget_from_list, cpuput_Onto_list, cpuget_all_from_list, and cpuput_chain_onto_list.

Process 400 begins by receiving a call from a kernel service for the insertion or removal of a list element from a linked list (step 410). The call can be an atomic operation free atomic list primitive, including cpuget_from_list, cpuput_onto_list, cpuget_all_from_list, and cpuput_chain_onto_list. Responsive to receiving the call, process 400 begins execution of atomic operation free atomic list primitives (step 420).

During execution, a first-level interrupt handler monitors the state of the interrupted program The interrupted address is known to the first-level interrupt handler. If the interrupt hander identifies that an interrupt is received during execution of the atomic operation free atomic list primitive (“yes” at step 430), the interrupt hander resets the instruction address register in the interrupted machine state save area (MST) (step 440). The instruction address register, also known as a program counter, is a register in the central processing unit that contains the address of the next instruction to be executed. The instruction address register is automatically incremented after each instruction is fetched to point to the following instruction. Process 400 then returns to step 420 to restart execution of the atomic operation free atomic list primitive. Because the sequences in the atomic operation free atomic list primitives are written so that they are restartable up to the terminating store that completes the list transaction, the interrupt hander has clear boundaries to determine restartability.

Returning now to step 430, if the interrupt hander does not identify that an interrupt is received during execution of the atomic operation free atomic list primitive (“no” at step 430), process 400 finishes execution of the list primitive (step 450), with the process terminating thereafter.

FIG. 5 is an exemplary diagram illustrating a linked list according to an illustrative embodiment. As shown in FIG. 5, the linked list 500 is comprised of one or more list elements 510. The list elements 510 may simply be pointers to data, may include the data itself, or may be more complex data structures having pointers, data, and other information appropriate to the particular implementation.

In the depicted example, the list elements 510 include a pointer data structure 520 that points to next list element 512 in the linked list. Similarly, next list element 512 includes a pointer data structure 522 that points to next list element 514 in the linked list. The each of list elements 510, 512, and 514 further include a garbage collection flag data structure 530 which is used to mark list elements for garbage collection. The list elements 510, 512, and 514 may include other data structures not explicitly shown in FIG. 5. It should be appreciated that while FIG. 5 illustrates the linked list 500 as a top-down linked list, the opposite configuration, a bottom-up linked list, may be utilized. Head pointer 540, which may be stored in a data structure associated with the linked list 500, points to the head of the linked list 500. Offset 550 is used to offset elements within linked list 500 from certain list elements 510, 512, and 514 marked with head pointer 540 into the linked list 500. Offset 550 is determined based on a known size of list elements 510 within linked list 500. Using head pointer 540 and offset 550, a certain list element within linked list 500 may be identified.

While many kernel services use atomic primitives to serialize list insertion and removal, the underlying LARX/STCX operations of the primitives are very expensive in terms of processor utilization. Regular load and store instructions are less processor intensive.

By carefully organizing its contained data, a kernel service can use an atomic operation free atomic list primitive so that the target lists are only accessed by the owning CPU. The illustrative embodiments utilize a base address of a list structure, a stride of the list structure, and the offset into the structure of the list being updated to identify a linked list for each CPU within the data processing system. The disclosed primitive operations are then performed on the identified list that corresponds to the CPU on which the low level, primitive calling routine is executed.

The atomic operation free atomic list primitives are per-CPU list, restartable millicode routines, including cpuget_from_list, cpuput_Onto_list, cpuget_all_from_list, and cpuput_chain_onto_list. The atomic operation free atomic list primitives are implemented in millicode such that if any of the atomic operation free atomic list primitives are interrupted, a first level interrupt handler will have knowledge that the sequence has been interrupted, and the handler will reset the IAR in the interrupted MST. The entire atomic operation free atomic list primitive will then be restarted when the interrupted thread is resumed. Because the sequences of atomic operation free atomic list primitives are written so that they are restartable up to the terminating store that completes the list transaction, the interrupt hander has clear boundaries to determine restartability.

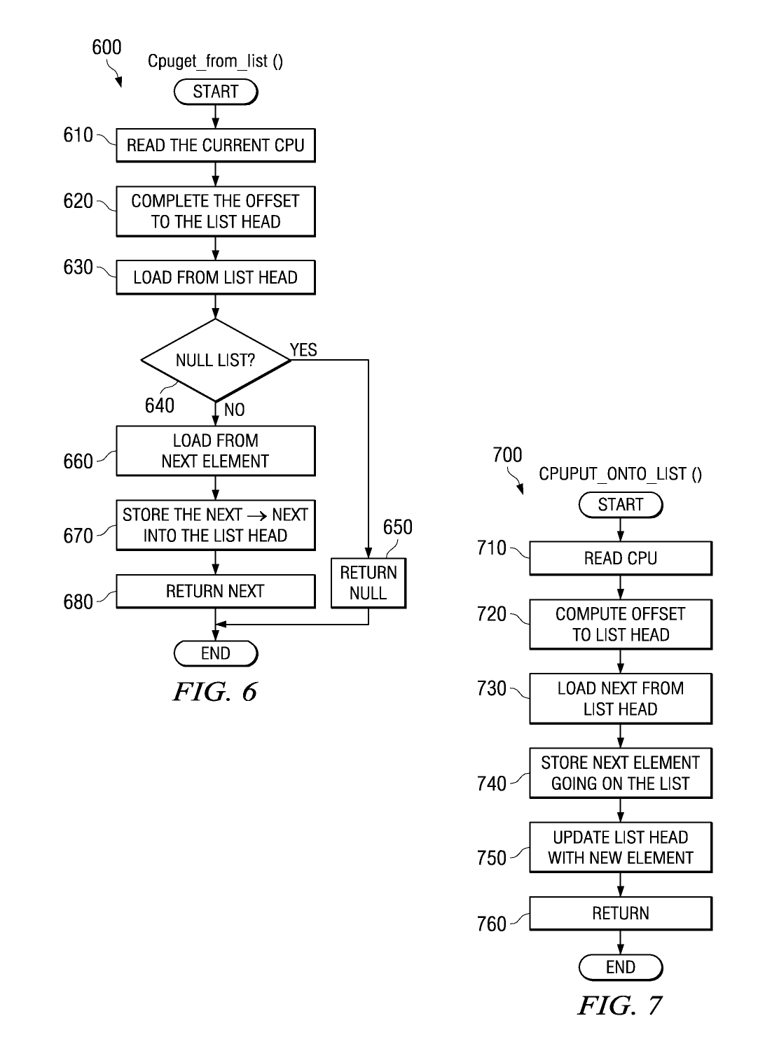

Referring now to FIG. 6, a flowchart illustrating a retrieval of a list element from a linked list is shown according to an illustrative embodiment. Process 600 can be implemented as millicode within a XXX, such as XXX of FIG. 1. Process 600 can be implemented as primitive cpuget_from_list.

Process 600 begins by reading the current CPU (step 610). The current CPU can be a logical partition, such as one of logical partitions, P1, P2, and P3 of data processing system 100 of FIG. 1. By verifying the current CPU, process 600 ensures that only the current CPU has access to data within the corresponding linked list structure, which can be linked list 500 of FIG. 5.

Responsive to process 600 reading the current CPU, process 600 identifies the offset to the list head corresponding to the list structure for the current CPU (step 620). In one illustrative embodiment, process 600 identifies the offset to the current CPU list head by accounting for the structure size of the list. Each successive factor of the structure size corresponds to a certain CPU. Therefore, once the structure size and the current CPU are known, the offset to the current CPU list head can be easily identified by multiplying the structure size and the current CPU to get a size-delineated offset to the list head of the current CPU.

Responsive to identifying the offset to the list head corresponding to the list structure for the current CPU, process 600 loads from the list head (step 630). Process 600 therefore follows the pointer of the list head to the list element of the linked list. If the linked list does not contain any list elements, then it is a null list. Responsive to loading from the first list head, process 600 identifies whether the linked list is a null list (step 640). A null list does not contain any list elements. If process 600 identifies the linked list is a null list (“yes” at step 640), process 600 returns an indication that the list is a null list (step 650) with the process terminating thereafter. Because the linked list does not contain any list elements, no list elements can be retrieved by a kernel call to the list.

Returning now to step 640, if process 600 does not identify the linked list is a null list (“no” at step 640), process 600 loads data from the next element in the linked list (step 660). The next element is that list element, such as list element 510 of FIG. 5, that is indicated by the pointer from the list head. Process 600 loads any data contained within that next element.

Responsive to loading from the next element in the linked list, process 600 stores the next-next list element into the list head (step 670). The next-next list element is that list element that is indicated by the pointer from the next list element. By storing the next-next list element into the list head, the list head now points the next-next list element. The next list element is no longer linked within the linked list.

Responsive to storing the next-next list element into the list head, process 600 then returns the next list element (step 680) with the process terminating thereafter. The next list element is returned to the kernel service that called the cpuget_from_list primitive. The next-next list element is now indicated by the head pointer, such that a subsequent cpuget_from_list call would return the next-next list element. Thus, the next-next list element becomes the next list element for the subsequent cpuget_from_list call.

Referring now to FIG. 7, a flowchart illustrating an allocation of a list element to a linked list is shown according to an illustrative embodiment. Process 700 can be implemented as millicode within a XXX, such as XXX of FIG. 1. Process 700 can be implemented as primitive cpuput_onto_list.

Process 700 begins by reading the current CPU (step 710). By verifying the current CPU, process 700 ensures that only the current CPU has access to data within the corresponding linked list structure, which can be linked list 500 of FIG. 5.

Responsive to process 700 reading the current CPU, process 700 identifies the offset to the list head corresponding to the list structure for the current CPU (step 720). In one illustrative embodiment, process 700 identifies the offset to the current CPU list head by accounting for the structure size of the list. Each successive factor of the structure size corresponds to a certain CPU. Therefore, once the structure size and the current CPU are known, the offset to the current CPU list head can be easily identified by multiplying the structure size and the current CPU to get a size-delineated offset to the list head of the current CPU.

Responsive to identifying the offset to the list head corresponding to the list structure for the current CPU, process 700 loads from the list head (step 730). Process 700 therefore follows the pointer of the list head to the list element of the linked list. If the linked list does not contain any list elements, then it is a null list.

Responsive to loading from the list head, process 700 stores the next list element going onto the list (step 740). The next list element is stored within the data structure for the identified CPU, and the address of the next list element is identified. A data pointer for the new list element is set to identify the previous list head.

Responsive to storing the next list element, process 700 updates the list head with the new list element (step 750). By updating the list head with the new list element, the list head now points to the new list element as being at the top of the stack. The new list element is now linked within the linked list.

Having stored the new list element within the linked list, process 700 returns control to the kernel service that called the primitive (step 760), with the process terminating thereafter. The kernel service is then free to perform the next actions of a thread or process.

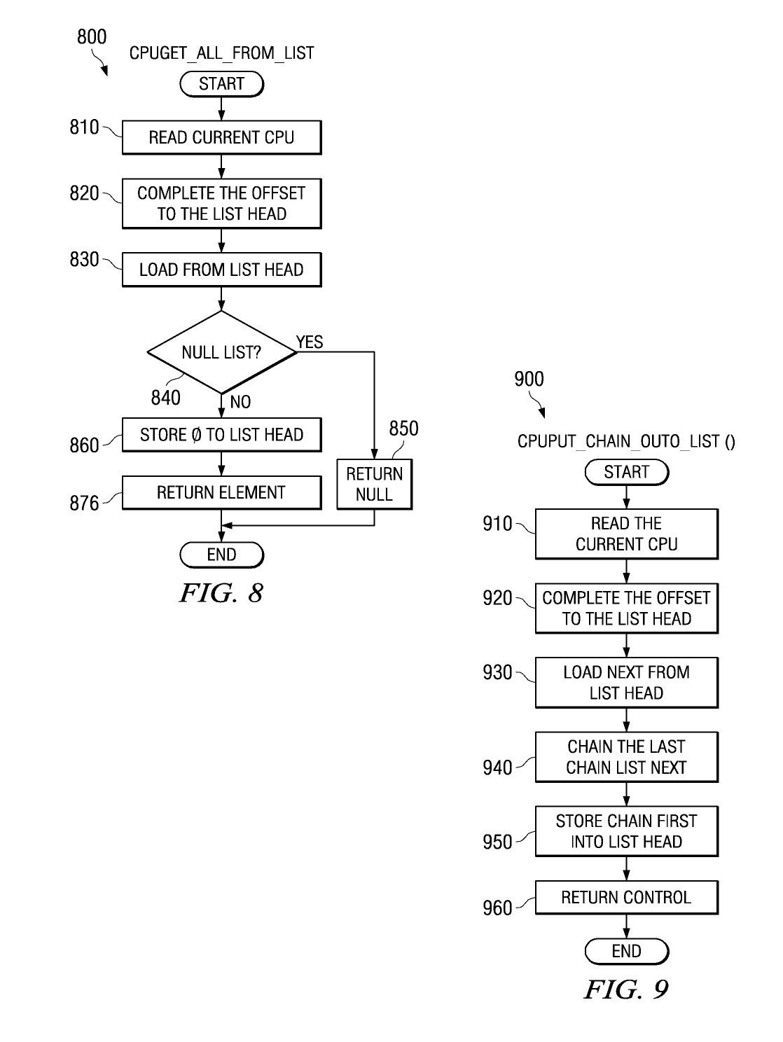

Referring now to FIG. 8, a flowchart illustrating a retrieval of all list elements from a linked list is shown according to an illustrative embodiment. Process 800 can be implemented as millicode within a XXX, such as XXX of FIG. 1. Process 800 can be implemented as primitive cpuget_all_from_list.

Process 800 begins by reading the current CPU (step 810). The current CPU is read from (where is this information retrieved from?). By verifying the current CPU, process 800 ensures that only the current CPU has access to data within the corresponding linked list structure, which can be linked list 500 of FIG. 5.

Responsive to process 800 reading the current CPU, process 800 identifies the offset to the list head corresponding to the list structure for the current CPU (step 820). In one illustrative embodiment, process 800 identifies the offset to the current CPU list head by accounting for the structure size of the list. Each successive factor of the structure size corresponds to a certain CPU. Therefore, once the structure size and the current CPU are known, the offset to the current CPU list head can be easily identified by multiplying the structure size and the current CPU to get a size-delineated offset to the list head of the current CPU.

Responsive to identifying the offset to the list head corresponding to the list structure for the current CPU, process 800 loads from the list head (step 830). Process 800 therefore follows the pointer of the list head to the list element of the linked list. If the linked list does not contain any list elements, then it is a null list.

Responsive to loading from the first list head, process 800 identifies whether the linked list is a null list (step 840). A null list does not contain any list elements. If process 800 identifies the linked list is a null list (“yes” at step 840), process 800 returns an indication that the list is a null list (step 850) with the process terminating thereafter. Because the linked list does not contain any list elements, no list elements can be retrieved by a kernel call to the list.

Returning now to step 840, if process 800 does not identify the linked list is a null list (“no” at step 840), process 800 stores a null value list element into the list head (step 860). The null value list element indicates that the linked list contains no list elements. The list head now points the null value list element.

Responsive to storing the null value list element into the list head, process 800 then returns the retrieved list elements (step 870) with the process terminating thereafter. The retrieved list elements are returned to the kernel service that called the cpuget_all_from_list primitive. The null value list element is now indicated by the head pointer, such that a subsequent cpuget_from_list call would return an indication of a null list.

Referring now to FIG. 9, a flowchart illustrating an allocation of a list element chain to a linked list is shown according to an illustrative embodiment. Process 900 can be implemented as millicode within a XXX, such as XXX of FIG. 3. Process 900 can be implemented as primitive cpuput_chain_onto_list.

Process 900 begins by reading the current CPU (step 910). The current CPU is read from the per-processor data area (PPDA) By verifying the current CPU, process 900 ensures that only the current CPU has access to data within the corresponding linked list structure, which can be linked list 500 of FIG. 5.

Responsive to process 900 reading the current CPU, process 900 identifies the offset to the list head corresponding to the list structure for the current CPU (step 920). In one illustrative embodiment, process 900 identifies the offset to the current CPU list head by accounting for the structure size of the list. Each successive factor of the structure size corresponds to a certain CPU. Therefore, once the structure size and the current CPU are known, the offset to the current CPU list head can be easily identified by multiplying the structure size and the current CPU to get a size-delineated offset to the list head of the current CPU.

Responsive to identifying the offset to the list head corresponding to the list structure for the current CPU, process 900 loads from the list head (step 930). Process 900 therefore follows the pointer of the list head to the list element of the linked list. If the linked list does not contain any list elements, then it is a null list.

Responsive to loading from the list head, process 900 stores the next list element chain going onto the list (step 940). The next list element chain is stored within the data structure for the identified CPU, and the addresses of the next list element chain are identified. A data pointer for the new list element chain is set to identify the previous first element, such that the list head now points the first list element of the chain being placed into the linked list. Further, a pointer within the last element of the next list element chain is set to point to the previous first element.

Responsive to storing the next list element chain, process 900 updates the list head with the first element of the new list element chain (step 950). By updating the list head with the first element of the new list element chain, the list head now points that first element of as being at the top of the stack. The new list element chain is now linked within the linked list.

Having stored the new list element within the linked list, process 900 returns control to the kernel service that called the primitive (step 960), with the process terminating thereafter. The kernel service is then free to perform the next actions of a thread or process.

Thus, the illustrative embodiments provide a computer implemented method, a computer program product, and a data processing system for serializing list insertion and removal. By carefully organizing its contained data, a kernel service can use an atomic operation free atomic list primitive so that the target lists are only accessed by the owning CPU. The illustrative embodiments utilize a base address of a list structure, a stride of the list structure, and the offset into the structure of the list being updated to identify a linked list for each CPU within the data processing system. The disclosed primitive operations are then performed on the identified list that corresponds to the CPU on which the low level, primitive calling routine is executed.

A computer implemented method, a data processing system, and a computer usable recordable-type medium having a computer usable program code serializing list insertion and removal. An atomic operation free atomic list primitive call from a kernel service is received for the insertion or removal of a list element from a linked list. The atomic operation free atomic list primitive is a restartible routine selected from the list consisting of cpuget_from_list, cpuput_onto_list, cpuget_all_from_list, and cpuput_chain_onto_list. A processor begins execution of the atomic operation free atomic list primitive. If an interrupt is received during execution of the atomic operation free atomic list primitive, the interrupt handler will recognize the address of the executing program at the time of the interrupt, and will over-write that address in the machine state save area, so that when the interrupted program is resumed, the entire primitive sequence will be run from the beginning If an interrupt is not received during execution of the atomic operation free atomic list primitive, the processor finishes execution of the atomic operation free atomic list primitive.

The atomic operation free atomic list primitives are per-CPU list, restartable millicode routines, including cpuget_from_list, cpuput_Onto_list, cpuget_all_from_list, and cpuput_chain_onto_list. The atomic operation free atomic list primitives are implemented in millicode such that if any of the atomic operation free atomic list primitives are interrupted, a first level interrupt handler will have knowledge that the sequence has been interrupted, and the handler will reset the IAR in the interrupted MST. The entire atomic operation free atomic list primitive will then be restarted when the interrupted thread is resumed. Because the sequences of atomic operation free atomic list primitives are written so that they are restartable up to the terminating store that completes the list transaction, the interrupt hander has clear boundaries to determine restartability.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can be carried out in the AIX kernel in the memory allocation subsystem. Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for serializing list insertion and removal, the computer implemented method comprising:
receiving an atomic operation free atomic list primitive call from a kernel service for the insertion or removal of a list element from a linked list;
beginning execution of the atomic operation free atomic list primitive;
identifying whether an interrupt is received during execution of the atomic operation free atomic list primitive;
responsive to identifying that an interrupt is received during execution of the atomic operation free atomic list primitive interrupt hander, resetting an instruction address register in the interrupted machine state save area; and
responsive to not identifying that an interrupt is received during execution of the atomic operation free atomic list primitive, finishing execution of the atomic operation free atomic list primitive.

2. The computer implemented method of claim 1, further comprising:
receiving an atomic operation free atomic list primitive call from a kernel service for the insertion or removal of a list element from a linked list, wherein the atomic operation free atomic list primitive is a restartible routine selected from the list consisting of cpuget_from_list, cpuput_Onto_list, cpuget_all_from_list, and cpuput_chain_onto_list.

3. The computer implemented method of claim 2, wherein the atomic operation free atomic list primitive is a restartible millicode routine.

4. The computer implemented method of claim 2, wherein the atomic operation free atomic list primitive comprises:
identifying a current processor associated with the linked list;
identifying an offset to a list head corresponding to a list structure for the current processor; and
loading from the list head.

5. The computer implemented method of claim 4, wherein the atomic operation free atomic list primitive is cpuget_from_list, wherein the atomic operation free atomic list primitive further comprises:
identifying whether the linked list is a null list;
responsive to not identifying that the linked list is a null list, loading data from a next element in the linked list; and
returning the next list element.

6. The computer implemented method of claim 4, wherein the atomic operation free atomic list primitive is cpuput_onto_list, wherein the atomic operation free atomic list primitive further comprises:
storing a next list element going onto the linked list;
updating the list head with the next list element; and
returning control to the kernel service that called the atomic operation free atomic list primitive.

7. The computer implemented method of claim 4, wherein the atomic operation free atomic list primitive is cpuget_all_from_list, wherein the atomic operation free atomic list primitive further comprises:
identifying whether the linked list is a null list;
responsive to not identifying that the linked list is a null list, storing a null value list element into the list head; and
returning all list elements.

8. The computer implemented method of claim 4, wherein the atomic operation free atomic list primitive is cpuput_chain_onto_list, wherein the atomic operation free atomic list primitive further comprises:
storing a new list element chain going onto the linked list;
updating the list head with a first list element of the new list element chain; and
returning control to the kernel service that called the atomic operation free atomic list primitive.

9. A data processing system comprising:
a bus;
a storage device connected to the bus, wherein the storage device contains computer usable code for serializing list insertion and removal;
a communications unit connected to the bus; and
a processing unit connected to the bus, wherein the processing unit executes the computer usable code to receive an atomic operation free atomic list primitive call from a kernel service for the insertion or removal of a list element from a linked list; to begin execution of the atomic operation free atomic list primitive; to identify whether an interrupt is received during execution of the atomic operation free atomic list primitive; responsive to identifying that an interrupt is received during execution of the atomic operation free atomic list primitive interrupt hander, to reset an instruction address register in the interrupted machine state save area; and responsive to not identifying that an interrupt is received during execution of the atomic operation free atomic list primitive, to finish execution of the atomic operation free atomic list primitive.

10. The data processing system of claim 9, wherein the processing unit further executes the computer usable code to receive an atomic operation free atomic list primitive call from a kernel service for the insertion or removal of a list element from a linked list, wherein the atomic operation free atomic list primitive is a restartible routine selected from the list consisting of cpuget_from_list, cpuput_onto_list, cpuget_all_from_list, and cpuput_chain_onto_list.

11. The data processing system of claim 10, wherein the processing unit further executes the computer usable code to execute the atomic operation free atomic list primitive to identify a current processor associated with the linked list; to identify an offset to a list head corresponding to a list structure for the current processor; and to load from the list head.

12. The data processing system of claim 11, wherein the atomic operation free atomic list primitive is cpuget_from_list, wherein the processing unit further executes the computer usable code to execute the atomic operation free atomic list primitive to identify whether the linked list is a null list; responsive to not identifying that the linked list is a null list, to load data from a next element in the linked list; and to return the next list element.

13. The data processing system of claim 11, wherein the atomic operation free atomic list primitive is cpuput_onto_list, wherein the processing unit further executes the computer usable code to execute the atomic operation free atomic list primitive to store a next list element going onto the linked list; to update the list head with the next list element; and to return control to the kernel service that called the atomic operation free atomic list primitive.

14. The data processing system of claim 11, wherein the atomic operation free atomic list primitive is cpuget_all_from_list, wherein the processing unit further executes the computer usable code to identify whether the linked list is a null list; responsive to not identifying that the linked list is a null list, to store a null value list element into the list head; and to return all list elements.

15. The data processing system of claim 11, wherein the atomic operation free atomic list primitive is cpuput_chain_onto_list, wherein the processing unit further executes the computer usable code to store a new list element chain going onto the linked list; to update the list head with a first list element of the new list element chain; and to return control to the kernel service that called the atomic operation free atomic list primitive.

16. A computer usable recordable-type medium having a computer usable program code for serializing list insertion and removal, the computer usable program code comprising:
computer usable program code for receiving an atomic operation free atomic list primitive call from a kernel service for the insertion or removal of a list element from a linked list, wherein the atomic operation free atomic list primitive is a restartible routine selected from the list consisting of cpuget_from_list, cpuput_onto_list, cpuget_all_from_list, and cpuput_chain_onto_list;
computer usable program code for beginning execution of the atomic operation free atomic list primitive;
computer usable program code for identifying whether an interrupt is received during execution of the atomic operation free atomic list primitive;
computer usable program code for responsive to identifying that an interrupt is received during execution of the atomic operation free atomic list primitive interrupt hander, resetting an instruction address register in the interrupted machine state save area;
computer usable program code for responsive to not identifying that an interrupt is received during execution of the atomic operation free atomic list primitive, finishing execution of the atomic operation free atomic list primitive.

17. The computer usable recordable-type medium having a computer usable program code of claim 16, wherein the atomic operation free atomic list primitive is cpuget_from_list, wherein the atomic operation free atomic list primitive further comprises:
computer usable program code for identifying whether the linked list is a null list;
computer usable program code, responsive to not identifying that the linked list is a null list, for loading data from a next element in the linked list; and
computer usable program code for returning the next list element.

18. The computer usable recordable-type medium having a computer usable program code of claim 16, wherein the atomic operation free atomic list primitive is cpuput_onto_list, wherein the atomic operation free atomic list primitive further comprises:
computer usable program code for storing a next list element going onto the linked list;
computer usable program code for updating the list head with the next list element; and
computer usable program code for returning control to the kernel service that called the atomic operation free atomic list primitive.

19. The computer usable recordable-type medium having a computer usable program code of claim 16, wherein the atomic operation free atomic list primitive is cpuget_all_from_list, wherein the atomic operation free atomic list primitive further comprises:
computer usable program code for identifying whether the linked list is a null list;
computer usable program code, responsive to not identifying that the linked list is a null list, for storing a null value list element into the list head; and
computer usable program code for returning all list elements.

20. The computer usable recordable-type medium having a computer usable program code of claim 16, wherein the atomic operation free atomic list primitive is cpuput_chain_onto_list, wherein the atomic operation free atomic list primitive further comprises:
computer usable program code for storing a new list element chain going onto the linked list;
computer usable program code for updating the list head with a first list element of the new list element chain; and
computer usable program code for returning control to the kernel service that called the atomic operation free atomic list primitive.
